(19) United States
(12) Patent Application Publication
(10) Pub. No.: US 2013/0013196 A1
(43) Pub. Date: Jan. 10, 2013

(54) NAVIGATION BLIND STARTUP

(75) Inventors: Christopher L. Dow, Clawson, MI (US); Todd E. Damon, Phoenix, AZ (US)

(73) Assignee: GENERAL MOTORS LLC, Detroit, MI (US)

(21) Appl. No.: 13/179,010

(22) Filed: Jul. 8, 2011

(51) Int. Cl. G01C 21/00

(52) U.S. Cl. 701/445; 701/450

(57) ABSTRACT

The described method and system provide for GPS navigation utilizing a previously stored position as a starting port when current position information is not available. The method may be implemented at a GPS-capable device (e.g. a telematics unit in one implementation) or through a call center that provides navigation services to a telecommunications device (e.g. a telematics unit in another implementation). A user input corresponding to an intended destination is received, it is determined whether current position information of the user is available; and, if not available, a route to the intended destination is calculated based on a previously stored position of the user. It may further be determined whether current position information of the user subsequently becomes available, and, when available, it may further be determined whether the user is on the calculated route that was based on the previously stored position of the user. If the user is not on route, a new route may be recalculated based on the current position of the user, which became available. In preferred implementations, the system and method are implemented within the context of a GPS unit that is part of a telematics unit in a vehicle.

### BACKGROUND OF THE INVENTION

Telematics units within mobile vehicles provide subscribers with connectivity to a telematics service provider (TSP). The TSP provides the subscriber with an array of services ranging from emergency call handling and stolen vehicle recovery to diagnostics monitoring and turn-by-turn navigation. Telematics units are often provisioned and activated at a point of sale when a subscriber purchases a telematics-equipped vehicle. Upon activation, the telematics unit can be utilized to provide a subscriber with the telematics services.

One of the services conventionally provided by TSPs is GPS (global positioning system) navigation, which may include the provision of Turn-by-Turn (TBT) directions. To use GPS navigation, a user of the telematics unit may enter a destination, and the GPS component of the telematics unit may provide directions (e.g. through a display and/or through vocal instructions) to the user based on a calculated course from the user's current location to the user's destination. When a user does not follow the directions and goes off-course (i.e., when the position of the vehicle is not on the calculated course), the GPS unit may recalculate a new course for the user to take based on the vehicle's position when it goes off-course.

When a user requests GPS position information or calculation of a route or TBT directions from a position of no visibility (e.g. an enclosed space such as a parking garage), or requests a route before the GPS hardware is fully started up, the user may be notified by the telematics unit or a TSP call center to move to an open area so that the GPS hardware can obtain a signal indicating the position of the user, or the user may be provided with standard routing requiring the user to input a starting location rather than relying on the user's current location. This is often an annoyance or inconvenience to the user.

Thus, it is an object in part to provide a system and method for providing accurate route information to the user without requiring the user to move to an open area or input a starting location. However, while this is an object underlying certain implementations of the invention, it will be appreciated that the invention is not limited to systems that solve the problems noted herein. Moreover, the inventors have created the above body of information merely for the convenience of the reader; the foregoing is a discussion of problems discovered and/or appreciated by the inventors, and is not an attempt to review or catalog the prior art.

### BRIEF SUMMARY OF THE INVENTION

The invention provides a system and method for GPS navigation utilizing a previously stored position as a starting port when current position information is not available. The method may be implemented at a GPS-capable device (e.g. a telematics unit in one implementation) or through a call center that provides navigation services to a telecommunications device (e.g. a telematics unit in another implementation). In either implementation, a user input corresponding to an intended destination is received, it is determined whether current position information of the user is available; and, if not available, a route to the intended destination is calculated based on a previously stored position of the user. Current position information may be unavailable when the user is in a region of no visibility or when device hardware for providing current position information is not started up.

In further implementations, it may further be determined whether current position information of the user becomes available, and, when available, it may further be determined whether the user is on the calculated route that was based on the previously stored position of the user. If the user is not on route, a new route may be recalculated based on the current position of the user, which became available.

In implementations where the route calculation is performed by a call center, the call center may be notified of information such as the user's previously stored position, whether current position information is available, and the user's current position and the call center may transmit route calculations and recalculations based on that information back to the user device. In yet another further implementation, when the call center is notified that current position information is unavailable, the call center may increase the amount of data sent to the user device.

The inventive principles described herein may be implemented as computer executable instructions on a tangible, non-transient computer-readable medium in a GPS system. In preferred implementations, the system and method are implemented within the context of a GPS unit that is part of a telematics unit in a vehicle.

Other objects and advantages of the invention will become apparent upon reading the following detailed description and upon reference to the drawings.

### BRIEF DESCRIPTION OF THE SEVERAL VIEWS OF THE DRAWINGS

FIG. 1 is a schematic diagram of an operating environment for a mobile vehicle communication system usable in implementations of the described principles;

FIG. 2 is a flowchart illustrating a process for utilizing a previously known position as a starting port when position information is not available in accordance with an implementation of the described principles;

FIG. 3 is a flowchart illustrating a process for utilizing a previously known position as a starting port when position information is not available in accordance with another implementation of the described principles; and

FIG. 4 is a diagram illustrating an example of an implementation of the described principles.

### DETAILED DESCRIPTION OF THE INVENTION

Before discussing the details of the invention and the environment wherein the invention may be used, a brief overview is given to guide the reader. In general terms, not intended to limit the claims, the invention is directed to a system and method for GPS navigation utilizing a previously stored position as a starting port when current position information is not available. In preferred implementations, the GPS navigation may be performed by a GPS unit that is part of a telematics system on a vehicle.

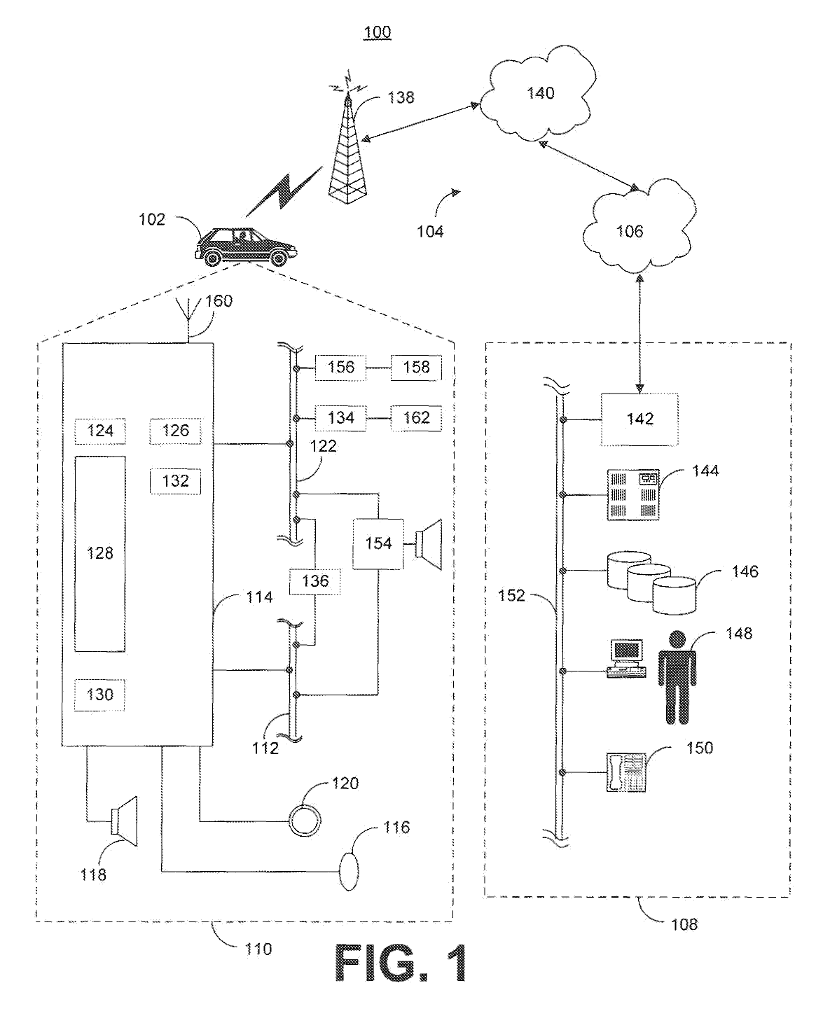

Given this overview, an exemplary environment in which the invention may operate is described hereinafter. It will be appreciated that the described environment is an example, and does not imply any limitation regarding the use of other environments to practice the invention. With reference to FIG. 1 there is shown an example of a communication system 100 that may be used with the present method and system and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128. The cellular chipset/component 124 and the wireless modem 126 may be called the network access device (NAD) of the telematics unit 114.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle.

GPS navigation services may be implemented based on the geographic position information of the vehicle provided by the GPS based chipset/component 132. A user of the telematics unit may enter a destination using inputs corresponding to the GPS component, and a route to a destination may be calculated based on the destination address and an inputted starting address, or a current position of the vehicle determined at approximately the time of route calculation, or, according to implementations of the present invention, based on a previously known position of the vehicle.

Turn-by-turn (TBT) directions may further be provided on a display screen corresponding to the GPS component and/or through vocal directions provided through a vehicle audio component 154. It will be appreciated that the calculation-related processing may occur at the telematics unit or may occur at a call center 108. It will be appreciated that TBT directions is merely a type of GPS navigation, and because the principles described herein are applicable to GPS navigation, they are equally applicable to GPS navigation through TBT directions. It will also be appreciated that the processing associated with GPS navigation/TBT directions may be carried out at a vehicle through a telematics unit, at a TSP call center, or both (e.g. the intelligence for route calculation may be implemented locally at the GPS unit of the vehicle, or may be implemented at the call center and provided wirelessly to the vehicle).

Infotainment-related services where music, Web pages, movies, television programs, video games and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit 114 is capable of offering. It is anticipated that telematics unit 114 include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission.

In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech.

The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit 114 via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server.

As appreciated by those skilled in the art, various cell tower/base station/MSC arrangements are possible and could be used with wireless system 104 (also referred to as the “cellular network” herein). For example, a base station and a cell tower could be co-located at the same site or they could be remotely located, and a single base station could be coupled to various cell towers or various base stations could be coupled with a single MSC, to name but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing.

The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

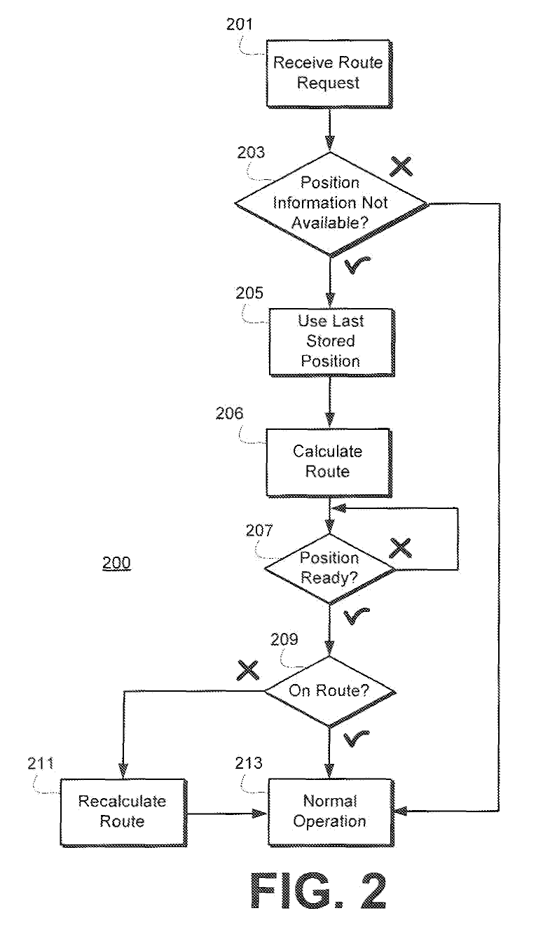

With further reference to the architecture of FIG. 1, and turning more specifically to FIG. 2, a process 200 for utilizing a previously known position of a vehicle for route calculation is depicted. The process 200 depicted in FIG. 2 is in the context of a telematics system where the route calculating intelligence is located at the telematics unit. The telematics unit first receives a route request from a user 201, which may include the user inputting a destination into the telematics unit. It will be appreciated that the route request may be received at any time, including before the vehicle engine is turned on, during the vehicle start-up, or when the vehicle is in transit.

If the current position of the vehicle is available when the route request is made 203, the telematics unit may provide normal GPS functions and provide a route to the user based on the vehicle's current position. If the telematics unit determines that the current position of the vehicle is not available 203, i.e., when the GPS hardware is still starting up or when the vehicle is in an area of no visibility, the telematics unit may use the last stored position 205 of the vehicle as the starting point for its route calculation 206. For example, a user may request route calculation while the user is in a covered parking garage (an area of no visibility), and instead of giving the user an error notification or instruction to move to an open area, the telematics unit performs route calculation 206 using the last known position of the vehicle 205, i.e., right before it entered the parking garage (the area of no visibility). Thus, the user would receive a route to the destination at least from just outside the parking garage, which will generally provide the user with an accurate and useful route.

Furthermore, the telematics unit continues to attempt to obtain current position information for the vehicle after the route based on the last stored position 205 is calculated 206. When position information becomes available 207, i.e., the vehicle leaves the area of no visibility or the GPS hardware finishes starting up, the telematics unit may then determine whether the user is on the route calculated based on the last stored position 209. If the vehicle is on route, the telematics unit may provide normal GPS functionality from that point on 213 since the current position of the vehicle is known and the vehicle is on route. If the vehicle is off route 209 when the position information becomes available 207, the telematics unit may recalculate the route for the user 211 and present a new route to the user based on the user's current position. In a further implementation, this route recalculation 211 may be performed silently to avoid annoyance to the user, since the user may not have ever gotten onto the original route provided to the user based on the vehicle's last stored position 205. In yet another further implementation, the telematics unit may notify the user that the route based on the last stored position did not contain their position and perform the route recalculation 211.

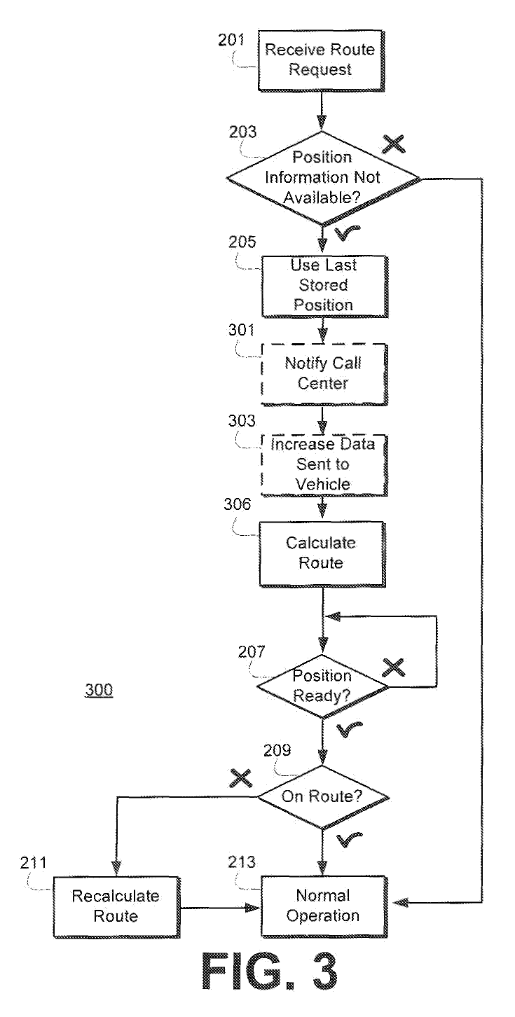

With further reference to the architecture of FIG. 1, and turning more specifically to FIG. 3, another process 300 for utilizing a previously known position of a vehicle for route calculation is depicted. The process 300 depicted in FIG. 3 is in the context of a telematics system where the route calculating intelligence is located at the call center. In this implementation, the call center first receives a route request 201, which may be received directly at the call center (e.g. through a telephone call to a TSP operator) or received through the telematics unit transmitting the route request to the call center. Then, the telematics unit or call center may then determine whether the current position information of the vehicle is available or not 203. It will be appreciated that the call center may determine whether the current position information of the vehicle is available or not in a variety of ways, including but not limited to being notified by the telematics unit (as described below), a lack of current position information being received from the telematics unit for some period of time, or sending a query to the telematics unit in response to the route request and receiving a response to the query from the telematics unit.

If the telematics unit determines that position information is not available, it notifies the call center of the last stored position of the vehicle if the last stored position 205 of the vehicle is stored at the telematics unit, and in a further implementation, notifies the call center 301 that the current position information is not available. In another further implementation, upon receiving notification that the current position is not available 301, the call center may increase the amount of data sent to the vehicle 303 to facilitate the provision of routing once position information becomes available.

The call center uses the last stored position of the vehicle 205, which may have been previously stored at the call center already or may have been provided to the call center by the telematics unit during the notification 301, to calculate a route and transmit the routing information to the vehicle 306. Once the current position of the vehicle becomes available 207, the telematics unit may determine whether the vehicle is on route 209, or the telematics unit may transmit the current location of the vehicle to the call center and the call center may determine whether the vehicle is on route 209. If the vehicle is not on route, a route recalculation may be performed by the call center and transmitted to the vehicle 211. In one further implementation, this route recalculation may be performed silently to avoid annoyance to the user. In another further implementation, the user may be notified that the route based on the last stored position did not contain the user's current location or the user may be notified that the route recalculation is being performed.

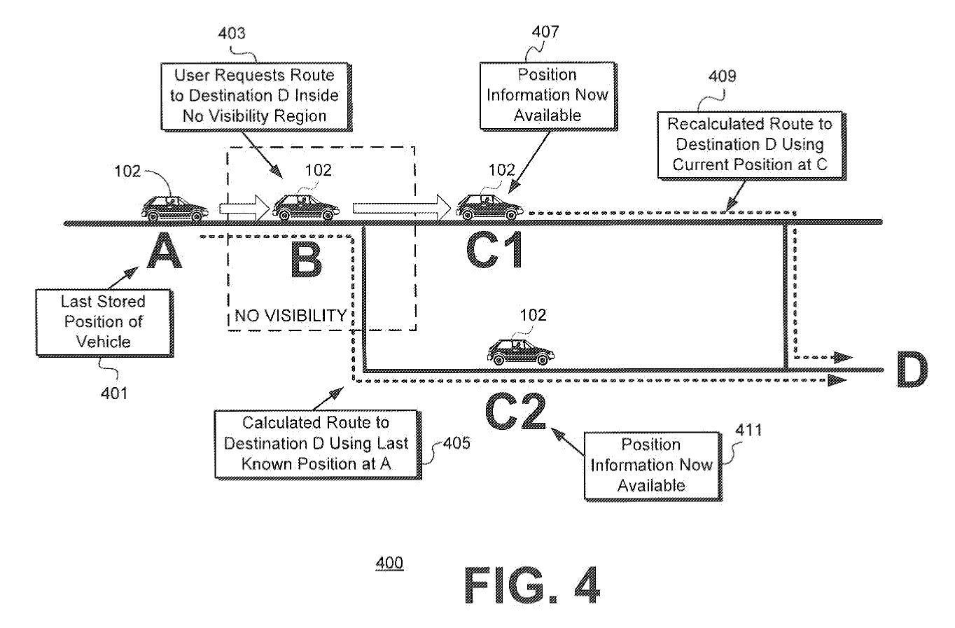

FIG. 4 is a diagram 400 depicting an example of an implementation of the inventive principles described herein. In this example, a vehicle 102 stores the position of the vehicle at point A before entering a region of no visibility. This stored position is the last known position 401 of the vehicle 102 when the vehicle 102 is at point B in the region of no visibility. When the vehicle 102 requests a route to a destination D while inside the region of no visibility 403, the telematics unit or call center provides the vehicle 102 with a calculated route to destination D using the last stored position at point A 405. However, as can be seen from FIG. 4, the vehicle 102 may have already begun progressing upon a different route within the region of no visibility when the route is calculated, represented by the vehicle 102 at point C1 in FIG. 4. Thus, when the vehicle 102 emerges from the region of no visibility and position information becomes available at point C1 407, the telematics unit or call center may determine that the user is not on the calculated route based on point A and recalculate the route to provide the user with another calculated route based on the vehicle's current position 409. After the route recalculation, the GPS navigation for the vehicle 102 may proceed in a conventional manner as the current position information of the vehicle 102 is available.

In a further example, using FIG. 4, a vehicle 102 stores the position of the vehicle at point A before entering a region of no visibility. This stored position is the last known position 401 of the vehicle 102 when the vehicle 102 is at point B in the region of no visibility. When the vehicle 102 requests a route to a destination D while inside the region of no visibility 403, the telematics unit or call center provides the vehicle 102 with a calculated route to destination D using the last stored position at point A 405. However, as can be seen from FIG. 4, the vehicle 102 may have already begun progressing upon the calculated route 405 within the region of no visibility, represented by the vehicle 102 at point C2 in FIG. 4. Thus, when the vehicle 102 emerges from the region of no visibility and position information becomes available at point C2 411, the telematics unit or call center may determine that the user is on the calculated route 405 based on point A and proceed in a conventional manner as the current position information of the vehicle 102 is available.

It will be appreciated by those of skill in the art that the execution of the various machine-implemented processes and steps described herein may occur via the computerized execution of computer-executable instructions stored on a tangible, non-transient computer-readable medium, e.g., RAM, ROM, PROM, volatile, nonvolatile, or other electronic memory mechanism. Thus, for example, the operations performed by the telematics unit may be carried out according to stored instructions or applications installed on the telematics unit, and operations performed at the call center may be carried out according to stored instructions or applications installed at the call center. It will further be appreciated that, although the above implementations have been described in the context of a telematics unit and vehicles, the principles described herein are not limited to telematics units or vehicles and may also be implemented on standalone GPS devices and other types of GPS navigation units (such as those provided on mobile phones).

It will thus be appreciated that the described system and method allows for GPS navigation utilizing a previously stored position as a starting port when current position information is not available. It will also be appreciated, however, that the foregoing methods and implementations are merely examples of the inventive principles, and that these illustrate only preferred techniques.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for GPS (Global Positioning System) navigation on a device with GPS capabilities, comprising:
receiving, at the device, input from a user corresponding to an intended destination;
determining whether current position information of the user is available; and
if the current position information of the user is determined to be not available, calculating a route to the intended destination based on a previously stored position of the user.

2. The method according to claim 1, wherein the current position information of the user is determined to be not available when at least one of the following conditions is met:
the user is in a region of no visibility; and
device hardware for providing current position information has not been started up.

3. The method according to claim 1, the method further comprising:
after calculating the route based on the previously stored position, determining whether current position information of the user becomes available.

4. The method according to claim 3, the method further comprising:
after determining that current position of the user is available, determining whether the user is on the calculated route; and
recalculating a new route based on the current position of the user if the user is determined not to be on the calculated route.

5. The method according to claim 1, wherein the device is a telematics unit on a telematics-equipped vehicle.

6. A method for GPS (Global Positioning System) navigation on a device with GPS capabilities, comprising:
receiving, at a call center, input from a user corresponding to an intended destination;
determining, at the call center, whether current position information of the user is available;
if the current position information of the user is not available, calculating a route to the intended destination based on a previously stored position of the user; and
transmitting the calculated route to the device.

7. The method according to claim 6, wherein the current position information of the user is determined to be not available when at least one of the following conditions is met:
the user is in a region of no visibility; and
device hardware for providing current position information has not been started up.

8. The method according to claim 6, wherein determining whether current position information of the user is available comprises:
receiving a notification from the device that current position information is not available.

9. The method according to claim 6, the method further comprising:
increasing the amount of data send to the device after determining that current position information of the user is not available.

10. The method according to claim 6, wherein the previously stored position of the user is received from the device.

11. The method according to claim 6, the method comprising:
after calculating the route based on the previously stored position, determining whether current position information of the user becomes available.

12. The method according to claim 11, wherein determining whether current position information of the user becomes available further comprises:
receiving current position information of the user from the device.

13. The method according to claim 11, the method further comprising:
after determining that current position of the user is available, determining whether the user is on the calculated route; and
recalculating a new route based on the current position of the user if the user is determined not to be on the calculated route.

14. The method according to claim 6, wherein the device is a telematics unit on a telematics-equipped vehicle.

15. A system for GPS (Global Positioning System) navigation, comprising a tangible, non-transient computer-readable medium having thereon computer executable instructions, the computer executable instructions comprising:
instructions for receiving an input from a user corresponding to an intended destination;
instructions for determining whether current position information of the user is available; and
instructions for calculating a route to the intended destination based on a previously stored position of the user if the current position information of the user is determined to be not available.

16. The system of claim 15, wherein the current position information of the user is determined to be not available when at least one of the following conditions is met:
the user is in a region of no visibility; and
device hardware for providing current position information has not been started up.

17. The system of claim 15, wherein the computer executable instructions further comprise:
instructions for determining whether current position information of the user becomes available after calculating the route based on the previously stored position.

18. The system of claim 17, wherein the computer executable instructions further comprise:
instructions for determining whether the user is on the calculated route after determining that current position of the user is available; and
instructions for recalculating a new route based on the current position of the user if the user is determined not to be on the calculated route.

19. The system of claim 15, wherein the tangible, non-transient computer-readable medium is part of a telematics unit in a vehicle.

20. The system of claim 15, wherein the tangible, non-transient computer-readable medium is located at a call center.
